(19) United States
(12) Patent Application Publication
(10) Pub. No.: US 2009/0229720 A1
(43) Pub. Date: Sep. 17, 2009

(54) PROCESS FOR PRODUCING TYRES, TYRES THUS OBTAINED AND ELASTOMERIC COMPOSITIONS USED THEREIN

(75) Inventors: Antonio SERRA, Genova (IT); Marco Nahmias Nanni, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pirelli Pneumatici S.P.A., Viale Sarca (IT)

(21) Appl. No.: 12/372,097

(22) Filed: May 4, 2009

Related U.S. Application Data
(63) Continuation of application No. 10/311,092, filed on Sep. 15, 2003.
(60) Provisional application No. 60/212,688, filed on Jun. 20, 2000.

(30) Foreign Application Priority Data
Jun. 14, 2000 (EP) 00112572.3

(51) Int. Cl. B60C 11/00; C08G 59/12; C08L 67/00; C08L 63/00; B29D 30/00

(52) U.S. Cl. 152/209.1; 528/365; 525/418; 524/599; 156/110.1

(57) ABSTRACT

Process for producing tyres, in which the crosslinking of a composition is carried out, this composition comprising: (a) an elastomeric polymer containing epoxide groups, and (b) an oligomer of a fatty acid. On heating, the elastomeric material reaches a high degree of crosslinking without the addition of conventional crosslinking agents, with crosslinking times contained within limits that are acceptable for industrial use. These compositions are particularly suitable for the production of tread bands.

The present invention relates to a process for producing tyres for the wheels of vehicles, to the tyres thus obtained and to the crosslinkable elastomeric compositions used therein. More particularly, the present invention relates to a process for producing tyres for the wheels of vehicles, which can be carried out substantially in the absence of conventional crosslinking agents, to the tyres thus obtained and to the crosslinkable compositions used therein.

Processes for vulcanizing diene elastomers with sulphur are widely used in the rubber industry for the production of a wide range of products, and in particular tyres for the wheels of vehicles. Although these processes give high-quality vulcanized products, they are considerably complicated to carry out, mainly due to the fact that, in order to obtain optimum vulcanization within industrially acceptable times, it is necessary to use a complex vulcanizing system which includes, besides sulphur or sulphur-donating compounds, one or more activators (for example stearic acid, zinc oxide and the like) and one or more accelerators (for example thiazoles, dithiocarbamates, thiurams, guanidines, sulphenamides and the like). The presence of these products can, in some cases, entail considerable problems in terms of the harmfulness/toxicity both during production and during use, in particular when the vulcanized products are intended for medical/health-care or food use. In addition, it is known that the use of sulphur or sulphur-donating compounds leads, during the vulcanization stage which is generally carried out at temperatures above 150° C., to the development of volatile sulphurized compounds.

Consequently, in recent years, research efforts have been directed along two different lines, the first being to improve the known vulcanization processes in order to make them more efficient and cleaner, the second aimed at developing alternative crosslinking techniques. Although appreciable progress has been made, it is not possible to state at the present time that alternative techniques to crosslinking with sulphur exist which would give similar results and would simultaneously afford an effective simplification in terms of production. For example, crosslinking processes by means of peroxide compounds require special precautions on account of the instability of these compounds, in addition to requiring the use of activators. Crosslinking by radiation involves the use of complex equipment, as well as the incorporation of all the precautions required when high-energy and high-power radiation is used.

The prior art discloses so-called “self-vulcanizing” elastomeric compositions, i.e. compositions which do not require the use of crosslinking agents such as sulphur or sulphur compounds.

For example, U.S. Pat. No. 2,724,707 describes elastomeric compositions consisting of a diene polymer containing free carboxylic groups, in particular a carboxylated nitrile rubber (XNBR) obtained by partial hydrolysis of a butadiene/acrylonitrile copolymer, in which is dispersed a multivalent metal oxide (for example zinc oxide). On heating, these compositions crosslink according to a mechanism of ionic type.

The article by S. K. Chakraborty and S. K. De, published in the Journal of Applied Polymer Science, Vol. 27, pp. 4561-4576 (1982), discloses a study on the crosslinking of XNBR with a high degree of carboxylation by reaction with an epoxy resin (for example bisphenol A diglycidyl ether) in the presence of reinforcing fillers such as carbon black, silica and clay. The crosslinking is carried out by heating the mixture to 150°-180° C. As is known, epoxy resins are low molecular weight products in which the epoxide (or oxirane) groups are “external”, i.e. they are located in the terminal position on the main hydrocarbon chain, the oxygen atom forming the oxirane ring being linked to the last and penultimate carbon atoms of the chain.

A study of the crosslinking of a composition based on epoxidized natural rubber (ENR) and on XNBR is reported in the article by R. Alex, P. P. De, N. M. Mathew and S. K. De, published in Plastics and Rubber Processing and Applications, Vol. 14, No. 4, 1990. In particular, that article discloses the crosslinking of compositions consisting of ENR and XNBR in unmodified form or containing silica or carbon black as reinforcing filler. According to the authors' disclosure, in the mixtures of ENR and XNBR, the crosslinking reaction comprises the formation of ester bonds between epoxide groups and carboxylic groups. The rheometric curves are said to show the absence of reversion, the stability of the crosslinked structure and the high speed of crosslinking.

U.S. Pat. No. 5,173,557 discloses self-vulcanizing compositions comprising an elastomeric polymer functionalized with isocyanate groups and a compound containing at least two active hydrogens of Zerewitinoff type, or self-vulcanizing compositions comprising an elastomeric polymer containing active hydrogens of Zerewitinoff type and a compound containing at least two isocyanate groups. Alternatively, an elastomeric polymer containing either isocyanate groups or active hydrogens of Zerewitinoff type can be used, without using an additional crosslinking agent. The active hydrogens can be present, for example, on hydroxide, amine, carboxylic or thiol groups. In order to avoid undesired pre-crosslinking of the elastomer, the isocyanate groups are blocked beforehand with suitable functional groups, which are removed by heating before the crosslinking reaction between the free isocyanate groups and the active hydrogens, optionally with the aid of a catalyst.

Italian patent IT-1 245 551 describes self-vulcanizing compositions containing an epoxidized elastomer and a vulcanizing agent of formula R1-R-R2, in which R is an arylene, alkylene or alkenylene group, while R1 and R2 are carboxylic, amine, sulphonic or chlorosulphonic groups. Dicarboxylic or polycarboxylic acids, or mixtures thereof, can be used as vulcanizing agents. Self-vulcanizing compositions containing an epoxidized elastomer and a second elastomer in which the repeating units of the polymer chain contain at least one carboxylic group are also described. For example, self-vulcanizing compositions are obtained by mixing an epoxidized elastomer (for example the products ENR 25 or ENR 50 which are available under the brand name Epoxiprene® from the Malaysian Rubber Producers Research Association) with terephthalic acid, sebacic acid or maleic acid. The crosslinking reaction takes place by heating the epoxide groups and the carboxylic groups, with formation of ester bonds.

On the basis of the Applicant's experience, the self-vulcanizing compositions proposed hitherto-in the prior art do not provide a valid alternative to conventional compositions vulcanized with sulphur or derivatives thereof. The reason for this is that the performance qualities of the crosslinked products are generally unsatisfactory, in particular for applications such as tyre compounds, in which high elastic and tensile performance qualities are required. This is the case, for example, for the self-crosslinking compositions described in patent IT-1 245 551 mentioned above, involving the use of vulcanizing agents containing carboxylic groups, in which the elongation at break of the elastomeric mixture thus obtained is, however, poor (generally it does not exceed a value of 200%) and is thus unacceptable for the majority of tyre applications such as, for example, the production of a tread band. In addition, dicarboxylic acids are usually in the form of crystalline solids with melting points of greater than 150° C. This leads, during the mixing phase, to poor dispersion of the crosslinking agent in the polymer.

The Applicant has now found, surprisingly, that crosslinked products, and in particular tyres for vehicle wheels, which have the desired combination of properties, can be produced, in the substantial absence of additional crosslinking agents, by using self-crosslinking compositions comprising a mixture of an elastomeric polymer containing epoxide groups and an oligomer of a fatty acid.

On heating, these compositions reach a high degree of crosslinking without the addition of conventional crosslinking agents, and with crosslinking times contained within limits that are acceptable for industrial use. The resulting crosslinked product combines excellent mechanical and elastic performance qualities, in particular stress at break, elongation at break, modulus and hardness, which are such that they make the self-crosslinking compositions mentioned above particularly suitable as elastomeric materials to be used for the production of tyres, in particular tread bands.

In addition, the use of fatty acid oligomers, which are usually in the form of liquids, makes it possible to obtain crosslinkable compositions having excellent processability and a high capacity to incorporate reinforcing fillers, even in the absence of compatibilizing additives, since these carboxylated products act not only as crosslinking agents but also as processing coadjuvants and are capable of interacting with reinforcing fillers containing active hydroxyl groups (for example silica) thus bringing about their compatibilization with the polymer matrix.

According to a first aspect, the present invention thus relates to a process for producing tyres for vehicle wheels, the said process comprising the following steps:

manufacturing a green tyre comprising at least one crosslinkable elastomeric material;

subjecting the green tyre to moulding in a mould cavity defined in a vulcanization mould;

crosslinking the elastomeric material by heating the tyre to a predetermined temperature and for a predetermined time;

characterized in that the crosslinkable elastomeric material comprises: (a) an elastomeric polymer containing epoxide groups, and (b) an oligomer of a fatty acid.

According to one preferred embodiment, the said crosslinking phase is carried out essentially without additional crosslinking agents.

According to another preferred aspect, the crosslinking phase is carried out by heating the crosslinkable elastomeric material to a temperature of at least 120° C., preferably of at least 160° C., for a period of at least 3 minutes, preferably of at least 10 minutes.

In accordance with a particularly preferred aspect, the said crosslinkable elastomeric material also comprises a reinforcing filler.

In a second aspect, the present invention relates to a tyre for vehicle wheels, comprising one or more components made of crosslinked elastomeric material, characterized in that at least one of the said components comprises, as crosslinked elastomeric material, an elastomeric polymer containing epoxide groups which is crosslinked by reaction with an oligomer of a fatty acid.

According to a further aspect, the present invention relates to a tyre for vehicles, comprising a belt structure which is extended coaxially around a carcass structure and a tread band which is extended coaxially around the belt structure and having, externally, a rolling surface which is intended to come into contact with the ground, characterized in that the said tread band comprises an elastomeric polymer containing epoxide groups which is crosslinked by reaction with an oligomer of a fatty acid.

According to a further aspect, the present invention relates to a tread band comprising a crosslinkable elastomeric composition comprising: (a) an elastomeric polymer containing epoxide groups, and (b) an oligomer of a fatty acid.

According to a further aspect, the present invention relates to a crosslinkable elastomeric composition comprising: (a) an elastomeric polymer containing epoxide groups, and (b) an oligomer of a fatty acid.

According to a further aspect, the present invention relates to a crosslinked elastomeric product obtained by crosslinking a crosslinkable composition as defined above.

For the purposes of the present description and the claims, the expression “in substantial absence of additional crosslinking agents” means that the crosslinkable composition is not subjected to the action of other systems capable of bringing about its crosslinking, or that other products which may be present in the composition can in themselves participate in the crosslinking reaction, but are used in amounts less than the minimum amount required to obtain an appreciable degree of crosslinking in a short time (for example within 5 minutes). In particular, the compositions according to the present invention are crosslinkable in substantial absence of any of the crosslinking systems usually used in the art, such as, for example, sulphur or sulphur donors, peroxides or other radical initiators, and neither are these compositions subjected to the action of high-energy radiation (UV, gamma rays, etc.) so as to induce crosslinking phenomena in the polymer.

The fatty acid oligomers are present, at ambient temperature, in the form of oils or viscous liquids.

The expression “oligomers of a fatty acid” means mixtures of products of different molecular weights, in particular dimers and trimers thereof (or of different starting fatty acids). The presence of unreacted monomers mixed with the fatty acid dimers and trimers in the final product is not excluded. These monomers can optionally be removed from the final product, for example by distillation. However, it is thought that the presence of the starting fatty acid does not compromise the properties of the composition.

The fatty acid oligomers according to the present invention are obtained, according to the known art, by reacting an unsaturated fatty acid or a mixture of fatty acids including at least one unsaturated fatty acid, under heating, in the presence of a catalyst, for example clay, active earth, montmorillonite or a mixture of disactivated clay and water.

Alternatively, the fatty acid oligomers can be obtained, by means of reactions similar to those described above, by oligomerizing the corresponding esters, followed by hydrolysis. Further details of the reactions described above can be found in U.S. Pat. Nos. 4,937,320, 4,776,983 and 5,880,298. It should be pointed out, however, that the presence of saturated fatty acids in the starting reaction mixture containing unsaturated fatty acids is not excluded. The fatty acids generally contain from 10 to 26 carbon atoms, preferably from 14 to 22 carbon atoms.

Examples of unsaturated fatty acids are: myristoleic acid, palmitoleic acid, oleic acid, gadoleic acid, erucic acid, ricinoleic acid, linoleic acid, linolenic acid, arachidonic acid and the like, or mixtures thereof.

Examples of saturated fatty acids which may be present in the mixture are: lauric acid, myristic acid, palmitic acid, stearic acid, behenic acid and the like, or mixtures thereof.

Particularly preferred starting materials from which to obtain the oligomers as described above are vegetable oils such as, for example: linseed oil, safflower oil, soybean oil, corn oil, cottonseed oil, rapeseed oil, castor oil, tung oil, tall oil, octyl tallate, sunflower oil, olive oil and the like, or mixtures thereof.

The polymers containing epoxide groups which can be used in the compositions according to the present invention are homopolymers or copolymers with elastomeric properties, having a glass transition temperature (T_{g}) of less than 23° C., preferably less than 0° C., containing from 1 to 60 mol %, preferably from 2 to 40 mol %, of epoxide groups relative to the total number of moles of monomers present in the polymer. Mixtures of different polymers containing epoxide groups, or alternatively mixtures of one or more epoxidized polymers with one or more non-epoxidized elastomeric polymers, also fall within this definition.

In the case of copolymers, these can have a random, block, grafted or mixed structure. The average molecular weight of the base polymer is preferably between 2000 and 1,000,000, preferably between 50,000 and 500,000.

In particular, epoxidized diene homopolymers or copolymers, in which the base polymer structure, of synthetic or natural origin, is derived from one or more conjugated diene monomers, optionally copolymerized with monovinylarenes and/or polar comonomers, are preferred.

The polymers which are particularly preferred are those derived from the (co)polymerization of diene monomers containing from 4 to 12, preferably from 4 to 8, carbon atoms, selected, for example, from: 1,3-butadiene, isoprene, 2,3-dimethyl-1,3-butadiene, 3-butyl-1,3-octadiene, 2-phenyl-1,3-butadiene and the like, or mixtures thereof. 1,3-Butadiene and isoprene are particularly preferred.

Monovinylarenes which can optionally be used as comonomers generally contain from 8 to 20, preferably from 8 to 12, carbon atoms and can be selected, for example, from: styrene; 1-vinylnaphthalene; 2-vinyl-naphthalene; various alkyl, cycloalkyl, aryl, alkylaryl or arylalkyl derivatives of styrene, such as, for example: 3-methylstyrene, 4-propylstyrene, 4-cyclo-hexylstyrene, 4-dodecylstyrene, 2-ethyl-4-benzyl-styrene, 4-p-tolylstyrene, 4-(4-phenylbutyl)styrene and the like, or mixtures thereof. Styrene is particularly preferred. These monovinylarenes can optionally be substituted with one or more functional groups, such as alkoxy groups, for example 4-methoxystyrene, amino groups, for example 4-dimethylaminostyrene, and the like.

Various polar comonomers can be introduced into the base polymer structure, in particular vinylpyridine, vinylquinoline, acrylic and alkylacrylic acid esters, nitrites and the like, or mixtures thereof, such as, for example: methyl acrylate, ethyl acrylate, methyl methacrylate, ethyl methacrylate, acrylonitrile and the like.

Among the diene polymers which are particularly preferred are: natural rubber, polybutadiene, polyisoprene, styrene/butadiene copolymers, butadiene/isoprene copolymers, styrene/isoprene copolymers, nitrile rubbers and the like, or mixtures thereof.

In the case of copolymers, the amount of diene comonomer relative to the other comonomers is such as to ensure that the final polymer has elastomeric properties. In this sense, it is not possible generally to establish the minimum amount of diene comonomer required to obtain the desired elastomeric properties. As a guide, an amount of diene comonomer of at least 50% by weight relative to the total weight of the comonomers can generally be considered sufficient.

The base diene polymer can be prepared according to known techniques, generally in emulsion, in suspension or in solution. The base polymer thus obtained is then subjected to epoxidization according to known techniques, for example by reaction in solution with an epoxidizing agent. This agent is generally a peroxide or a peracid, for example m-chloroperbenzoic acid, peracetic acid and the like, or hydrogen peroxide in the presence of a carboxylic acid or a derivative thereof, for example acetic acid, acetic anhydride and the like, optionally mixed with an acid catalyst such as sulphuric acid. Further details regarding processes for epoxidizing elastomeric polymers are described, for example, in U.S. Pat. No. 4,341,672 or by Schulz et al. in Rubber Chemistry and Technology, Vol. 55, p. 809 et seq.

Polymers containing epoxide groups which can also be used are elastomeric copolymers of one or more monoolefins with an olefinic comonomer containing one or more epoxide groups. The monoolefins can be selected from: ethylene and α-olefins generally containing from 3 to 12 carbon atoms, such as, for example: propylene, 1-butene, 1-pentene, 1-hexene, 1-octene and the like, or mixtures thereof. The following are preferred: copolymers between ethylene and an α-olefin, and optionally a diene; homopolymers of isobutene or copolymers thereof with minor amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexa-diene, 5-ethylidene-2-norbornene, 5-methylene-2-norbornene and the like. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; and the like, or mixtures thereof. Olefinic comonomers containing epoxide groups can be selected, for example, from: glycidyl acrylate, glycidyl methacrylate, vinylcyclohexene monoxide, allyl glycidyl ether and methallyl glycidyl ether. The introduction of the epoxide groups by the abovementioned epoxidized comonomers can be carried out by copolymerization of the corresponding monomers according to known techniques, in particular by radical copolymerization in emulsion. When a diene comonomer is present, this can be used to introduce epoxide groups by an epoxidation reaction as described above.

Examples of epoxidized elastomeric polymers which can be used in the present invention and which are currently commercially available are the products Epoxyprene® from Guthrie (epoxidized natural rubber—ENR) and the products Poly BD® from Elf Atochem (epoxidized polybutadiene).

In accordance with the present invention, the fatty acid oligomer is mixed with the epoxidized elastomeric polymer in variable proportions as a function of the amount of functional groups present and of the elastic properties which it is desired to give to the final product. The amounts of oligomer are generally between 3% and 50% by weight relative to the weight of the epoxidized polymer, preferably between 10% and 30% and even more preferably between 8% and 24%.

The crosslinkable compositions according to the present invention may contain reinforcing fillers, in an amount generally of between 30 phr and 120 phr (phr=parts by weight per 100 parts of polymer base). The reinforcing filler may be selected from those commonly used for crosslinked products, and in particular for tyres, such as: carbon black, silica, alumina, aluminosilicates, calcium carbonate, kaolin and the like, or mixtures thereof.

The crosslinkable compositions according to the present invention can comprise other commonly-used additives, selected on the basis of the specific application for which they are intended. For example, antioxidants, protective agents, plasticizers, compatibilizers for the reinforcing filler, adhesives, anti-ozonizing agents, modifying resins, fibres (for example Kevlar® pulp), and the like, can be added to these compositions.

In particular, in order to further improve the processability, a plasticizer, generally selected from mineral oils, vegetable oils, synthetic oils and the like, or mixtures thereof, for example: aromatic oil, naphthenic oil, phthalates, soybean oil and the like, can be added to the crosslinkable compositions according to the present invention. The amount of lubricant can generally range between 2 and 100 phr, preferably between 5 and 50 phr.

For the purpose of increasing the rate of crosslinking, an effective amount of a coupling catalyst can also be added to the crosslinkable compositions according to the present invention. This amount can vary within a wide range, and is generally between 0.01 and 5 parts by weight, preferably between 0.1 and 3 parts by weight, relative to 100 parts by weight of epoxidized elastomeric polymer. The catalyst can be selected from those known in the art for coupling reactions, and in particular:
carboxylates of metals such as tin, zinc, zirconium, iron, lead, cobalt, barium, calcium, manganese and the like, for example: dibutyltin dilaurate, dibutyltin diacetate, dioctyltin dilaurate, stannous acetate, stannous caprylate, lead naphthenate, zinc caprylate, zinc naphthenate, cobalt naphthenate, ferrous octanoate, iron 2-ethylhexanoate, and the like;
arylsulphonic acids or derivatives thereof, for example: p-dodecylbenzenesulphonic acid, tetrapropylbenzenesulphonic acid, acetyl-p-dodecylbenzenesulphonate, 1-naphthalenesulphonic acid, 2-naphthalenesulphonic acid, acetylmethane sulphonate, acetyl p-toluenesulphonate, and the like;
   strong inorganic acids or bases, such as sodium hydroxide, potassium hydroxide, hydrochloric acid, sulphuric acid, and the like;
   amines and alkanolamines, for example ethylamine, dibutylamine, hexylamine, pyridine, dimethylethanolamine, and the like; or mixtures thereof.

The crosslinkable compositions according to the present invention can be prepared by mixing the polymer base with the reinforcing filler which may be optionally present and with the other additives, according to techniques known in the art. The mixing can be carried out, for example, using an open-mill mixer, or an internal mixer of the type with tangential rotors (Banbury) or interpenetrating rotors (Intermix), or in continuous mixers of the Ko-Kneader (Buss) or co-rotating or counter-rotating twin-screw type.

During the mixing, the temperature is kept below a predetermined value so as to avoid premature crosslinking of the composition. To this end, the temperature is generally kept below 170° C., preferably below 150° C., even more preferably below 120° C. As regards the mixing time, this can vary within a wide range, depending mainly on the specific composition of the mixture, on the possible presence of fillers and on the type of mixer used. In general, a mixing time of greater than 90 sec, preferably between 3 and 35 min, is sufficient to obtain a homogeneous composition.

In order to optimize the dispersion of the filler while keeping the temperature below the values indicated above, multi-stage mixing processes can also be employed, optionally using a combination of different mixers arranged in series.

As an alternative to the abovementioned mixing processes, in order to improve the dispersion of the components, the crosslinkable compositions according to the present invention can advantageously be prepared by mixing the fatty acid oligomer, and optionally the reinforcing filler and the other additives, with the epoxidized polymer base in the form of an aqueous emulsion or a solution in an organic solvent. The optional filler can be used as such or in the form of a suspension or dispersion in an aqueous medium. The polymer is subsequently separated from the solvent or from the water by suitable means. For example, when a polymer in emulsion is used, the polymer can be precipitated, in the form of particles including the oily phase and the optional filler, by adding a coagulant. A coagulant which can be used in particular is an electrolytic solution, for example an aqueous sodium or potassium silicate solution. The coagulation process can be promoted by using a volatile organic solvent which is then removed by evaporation during precipitation of the filled polymer. Further details regarding processes of this type for the preparation of elastomeric compounds are given, for example, in U.S. Pat. No. 3,846,365.

The present invention will now be further illustrated by a number of implementation examples, with reference to:

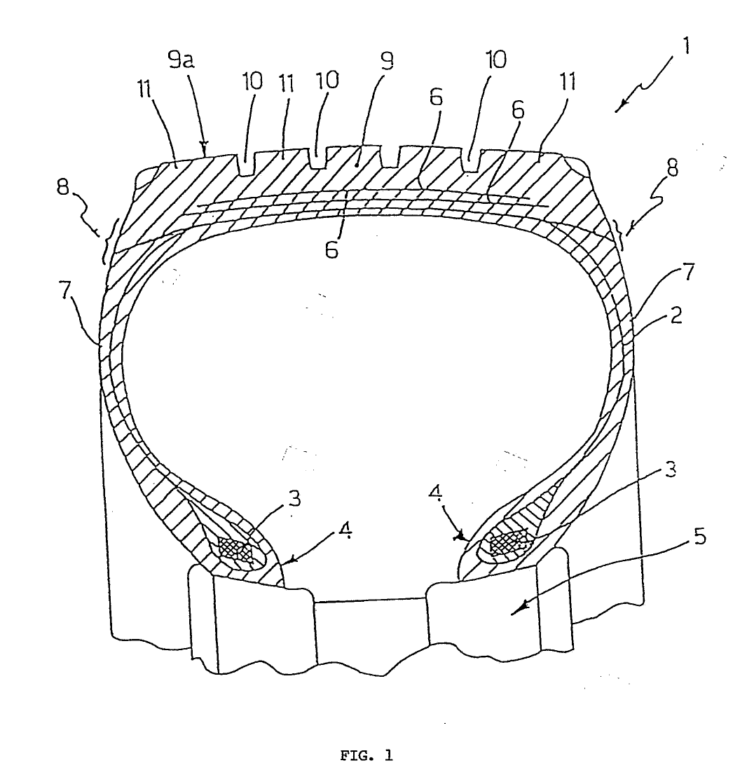

FIG. 1, attached, which shows a view in cross section with partial cutaway of a tyre according to the present invention.

With reference to FIG. 1, a tyre 1 conventionally comprises at least one carcass ply 2 whose opposite side edges are coupled to respective anchoring bead wires 3, each enclosed in α-bead 4 defined along an inner circumferential edge of the tyre, with which the tyre engages on a rim 5 forming part of the wheel of a vehicle.

The coupling between the carcass ply (2) and the bead wires (3) is usually carried out by folding the opposite lateral edges of the carcass ply (2) around the bead wires (3), so as to form the so-called carcass folds.

Alternatively, the conventional bead wires (3) can be replaced with a pair of circumferentially unextensible annular inserts formed from elongated components arranged in concentric spirals (not represented in FIG. 1) (see, for example, European patent applications EP-A-0 928 680 and EP-A-0 928 702). In this case, the carcass ply (2) is not folded around the said annular inserts, the coupling being provided by a second carcass ply (not represented in FIG. 1) applied externally onto the first.

Along the circumference of the carcass ply 2 are applied one or more belt strips 6, made using metal or textile cords enclosed in a rubber sheet. Outside the carcass ply 2, in respective opposite side portions of this ply, there is also applied a pair of side walls 7, each of which extends from the bead 4 to a so-called “shoulder” region 8 of the tyre, defined by the opposing ends of the belt strips 6. On the belt strips 6 is circumferentially applied a tread band 9 whose side edges end at the shoulders 8, joining it to the side walls 7. The tread band 9 has an external rolling surface 9a, intended to come into contact with the ground, in which circumferential grooves 10 intercalated with transverse cuttings (not shown in the attached figure) can be provided which define a plurality of blocks 11 variously distributed on the said rolling surface 9a.

The process for producing the tyre according to the present invention can be carried out according to techniques and using apparatus known in the art (see, for example, patents EP-199 064, U.S. Pat. No. 4,872,822 and U.S. Pat. No. 4,768,937). More particularly, this process comprises a step of manufacturing the green tyre, in which a series of semi-finished elements, prepared beforehand and separately from each other and corresponding to the various parts of the tyre (carcass plies, belt strips, bead wires, fillings, side walls and tread band) are combined together using a suitable manufacturing machine.

The green tyre thus obtained is then subjected to the subsequent steps of moulding and crosslinking. To this end, a vulcanization mould is used which is designed to receive the tyre being processed inside a moulding cavity having walls which are countermoulded to the outer surface of the tyre when the crosslinking is complete. Alternative processes for producing a tyre or tyre parts without using semi-finished elements are described, for example, in the abovementioned patent applications EP-A-0 928 680 and EP-A-0 928 702.

The green tyre can be moulded by introducing a pressurized fluid into the space defined by the inner surface of the tyre, so as to press the outer surface of the green tyre against the walls of the moulding cavity. In one of the moulding methods widely practised, it is provided that a vulcanization chamber made of elastomeric material, filled with steam and/or another pressurized fluid, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained (see, for example, patent EP-242 840). The difference in the coefficient of thermal expansion between the toroidal metal support and the crude elastomeric material is exploited to achieve an adequate moulding pressure.

At this point, the step of crosslinking of the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is brought to the crosslinking temperature using the same pressurized fluid used to press the tyre against the walls of the moulding cavity, heated to a maximum temperature of between 100 and 250° C. The time required to obtain a satisfactory degree of crosslinking throughout the mass of the elastomeric material can vary in general between 3 min and 90 min and depends mainly on the dimensions of the tyre.

The present invention will now be further illustrated, in a non-limiting manner, by a number of implementation examples.

### EXAMPLES 1-8

The compounds given in Table 1 were prepared using a tangential internal mixer, with a mixing time of about 30 min, taking care to keep the temperature as low as possible and, in any case, not above 120° C.

The Mooney ML(1+4) viscosity at 100° C. was measured on the non-crosslinked compositions, according to ISO standard 289/1. The compositions were then subjected to MDR rheometric analysis using an MDR rheometer from Monsanto, the tests being carried out at 200° C. for 30 min, with an oscillation frequency of 1.66 Hz (100 oscillations per minute) and an oscillation amplitude of ±0.5°. The minimum (ML) and maximum (MH) torque values are given in Table 2.

The mechanical properties (according to ISO standard 37) and the hardness in degrees IRHD (according to ISO standard 48) were measured on samples of the abovementioned compositions crosslinked at 200° C. for 15 min. The results are given in Table 2.

TABLE 1

| | 1* | 2* | 3 | 4 | 5 | 6 | 7 | 8 |
|---|---|---|---|---|---|---|---|---|
| ENR 25 | 100 | 100 | 100 | 100 | 100 | 100 | 100 | 100 |
| SEBACIC | 10 | 10 | | | | | | |
| ACID | | | | | | | | |
| FACIPOL ® | | | 6 | 12 | 24 | 6 | 12 | 24 |
| 120S | | | | | | | | |
| Carbon black | 70 | | 60 | 60 | 60 | | | |
| N234 | | | | | | | | |
| Zeosil ® 1165 | | 70 | | | | 60 | 60 | 60 |
| MP | | | | | | | | |

(*)comparative
Zeosil ® 1165: precipitated silica with a BET surface area equal to about 165 m²/g (Rhône-Poulenc)
ENR 25: epoxidized natural rubber containing 25 mol % of epoxide groups (Guthrie);
Facipol ® 120S: oligomer of a fatty acid containing 1% monomer, 79.5% dimer and 19.5% trimer, saponification number 198.7 mg KOH/g and acidity number 194 mg KOH/g) was supplied by FACI (Italy).

TABLE 2

| | 1* | 2* | 3 | 4 | 5 | 6 | 7 | 8 |
|---|---|---|---|---|---|---|---|---|
| MOONEY viscosity | (a) | (a) | 94.7 | 76.5 | 56.4 | (a) | (a) | (a) |
| ML (1 + 4) 100° C. | | | | | | | | |
| ML (dN · m) | 4.26 | 3.66 | 3.19 | 2.57 | 1.54 | 9.2 | 7.6 | 4.5 |
| MH (dN · m) | 56 | 39.9 | 16.6 | 19.8 | 25.4 | 28 | 34 | 27 |
| t90 (sec) | 23.1 | 22.6 | 25.8 | 25 | 23.3 | 24.4 | 25.4 | 23.9 |
| Stress at Break | 6.1 | 8.46 | 1.81 | 1.88 | 2.39 | 2.27 | 2.05 | 2.23 |
| 100% CA1 (MPa) | | | | | | | | |
| Stress at Break | (b) | (b) | 6.87 | 8.76 | 13 | 8.6 | 8.5 | 10.9 |
| 300% CA3 (MPa) | | | | | | | | |
| Stress at Break | 11.16 | 13.5 | 8.93 | 13 | 17.8 | 8.7 | 9.5 | 11.9 |
| (MPa) | | | | | | | | |
| Elongation at | 178 | 160 | 397 | 422 | 408 | 315 | 351 | 348 |
| break (%) | | | | | | | | |
| IRHD at 23° C. | 86.7 | 86.1 | 67.5 | 65 | 65.8 | 69 | 71 | 62.8 |
| (degrees) | | | | | | | | |
| IRHD at 100° C. | 80 | 76.5 | 47.6 | 51.5 | 58 | 55 | 56.5 | 58.5 |
| (degrees) | | | | | | | | |
| E′ 0° C. MPa | (a) | (a) | 20.2 | 17.2 | 17.3 | 14.9 | 13.5 | 12.9 |
| E′ 70° C. MPa | 13.2 | 19.5 | 7 | 5.7 | 5.9 | 5.5 | 4.8 | 4.6 |
| tan delta 0° C. | (a) | (a) | 0.565 | 0.614 | 0.656 | 0.582 | 0.647 | 0.720 |
| tan delta 70° C. | 0.118 | 0.144 | 0.221 | 0.220 | 0.168 | 0.186 | 0.184 | 0.115 |

Comparative
(a) value above the measurement limit of the instrument
(b) the sample breaks before reaching 300% elongation.

As can be seen from Table 2, the elongation values for the mixtures vulcanized with the oligomers are even more than twice that for the corresponding values of the reference mixtures (Comparative Examples 1 and 2).

Table 2 also gives the dynamic elastic modulus (E′) values measured at 0° C. and at 70° C. using a dynamic Instron device in tension-compression according to the following methods.

A cylindrical sample of the crosslinked material (length=25 mm; diameter=14 mm), preloaded in compression up to a longitudinal deformation of 10% relative to the initial length, and maintained at the preset temperature (0° C. or 70° C.) throughout the test, was subjected to a dynamic sinusoidal deformation with an amplitude of ±3.33% relative to the length under preloading, with a frequency of 100 Hz.

The modulus values and hardnesses of the compounds according to the present invention are lower and more suitable for use in tyres, in particular for producing a tread band.

### EXAMPLE 9

### Comparative

The comparative compound given in Table 3 was prepared using the same mixer as in the preceding examples.

The composition was crosslinked at 170° C. for 10 minutes and subjected to the same measurements indicated above for Examples 1-8.

The results are given in Table 4, in which they are placed in comparison with those of Example 8.

TABLE 3

| | EXAMPLE 9* |
|---|---|
| S-SBR | 70 |
| BR | 30 |
| Zeosil ®1165 MP | 63 |
| X50S | 10 |
| AROMATIC OIL | 5 |
| ZnO | 3 |
| STEARIC ACID | 2 |
| CBS | 2 |
| DPG | 1 |
| ANTIOXIDANTS | 4 |
| SULPHUR | 1.2 |

*comparative
S-SBR: butadiene/styrene copolymer produced in solution, with a styrene content equal to 20% by weight and a content of vinyl groups equal to 60% by weight (product Buna VSL ® 5025-1 HM from Bayer)
BR: polybutadiene (product Europrene Neocis ® from Enichem)
X50S: silane coupling agent including 50% by weight of carbon black and 50% by weight of bis(3-triethoxysilylpropyl) tetrasulphide (Degussa)
CBS: accelerator (N-cyclohexyl-benzothiazyl-sulphenamide Santocure ® from Monsanto
DPG: diphenylguanidine accelerator (Monsanto)
Zeosil ® 1165 MP: precipitated silica with a BET surface area equal to about 165 m²/g (Rhône-Poulenc)

From the data given in Table 4, it is clear that the compositions according to the present invention make it possible to obtain a crosslinked product with properties similar to those which can be obtained by the sulphur-crosslinking of a conventional tread band mixture. Moreover the following can be noted for the crosslinked compositions according to the present invention:
tan delta value at 0° C.—which, as is known, is an index of wet grip—which is higher and the compositions therefore have better performance qualities, compared with the value obtained with a reference compound;
an E′ value at 70° C.—which, as is known, is an index of the stability of the tread band when cornering under “dry handling” conditions—which is comparable (and thus a good response of the tyre to the stresses when cornering) with respect to the value which can be obtained with a reference compound;
a tan delta value at 70° C.—which, as is known, is an index of a lower rolling resistance—which is lower than the reference value and so indicates a lower rolling resistance.

It is also important to note that, for essentially equivalent performance qualities, the formulation of the compound was appreciably simplified compared with that of a traditional compound (from 11 to 5 ingredients: see Table 3), with evident advantages for an industrial production. In particular, in addition to not containing a vulcanizing system with sulphur, the compositions according to the invention, when filled with silica, do not require the presence of a coupling agent for silica and do not require a complex thermomechanical operating process, in order to obtain a good dispersion and compatibilization of the filler in the polymer matrix.

TABLE 4

| | EXAMPLE 9* | EXAMPLE 8 |
|---|---|---|
| MOONEY viscosity | 73 | (a) |
| ML (1 + 4) at 100° C. | | |
| Stress at Break (MPa) | 14.8 | 11.9 |
| Elongation at break (%) | 460.1 | 348 |
| IRHD at 23° C. (degrees) | 73.1 | 62.8 |
| IRHD at 100° C. (degrees) | 66.4 | 58.5 |
| E′ 0° C. (MPa) | 14.93 | 12.9 |
| Tan delta 0° C. | 0.587 | 0.720 |
| E′ 70° C. (MPa) | 5.87 | 4.6 |
| Tan delta 70° C. | 0.144 | 0.115 |

*comparative
(a) value greater than the measuring limit of the instrument

1-47. (canceled)

48. A process for producing a tyre for vehicle wheels, comprising:
manufacturing a tyre comprising at least one crosslinkable elastomeric material;
subjecting the tyre to moulding in a cavity defined in a vulcanization mould;
crosslinking the at least one elastomeric material by heating the tyre to a predetermined temperature and for a predetermined time;
wherein the at least one elastomeric material comprises:
an elastomeric polymer comprising epoxide groups; and
an oligomer of a fatty acid;
wherein the crosslinking is carried out substantially in an absence of additional crosslinking agents; and
wherein said elastomeric polymer comprising epoxide groups is the only polymer of said at least one elastomeric material.

49. The process of claim 48, wherein crosslinking is carried out by heating the at least one elastomeric material to a temperature greater than or equal to 120° C. for a period of at least 3 minutes.

50. The process of claim 48, wherein the at least one elastomeric material further comprises a reinforcing filler.

51. The process of claim 48, wherein the oligomer of a fatty acid comprises a dimer, a trimer, or a mixture of a dimer and a trimer.

52. The process of claim 48, wherein the fatty acid comprises at least one of myristoleic acid, palmitoleic acid, oleic acid, gadoleic acid, erucic acid, ricinoleic acid, linoleic acid, linolenic acid, and arachidonic acid.

53. The process of claim 48, wherein the fatty acid comprises vegetable oil.

54. The process of claim 53, wherein the vegetable oil comprises at least one of linseed oil, safflower oil, soybean oil, corn oil, cottonseed oil, rapeseed oil, castor oil, tung oil, tall oil, octyl tallate, sunflower oil, and olive oil.

55. The process of claim 48, wherein the elastomeric polymer comprising epoxide groups is a homopolymer or copolymer with elastomeric properties, comprising greater than or equal to 1 mol % and less than or equal to 60 mol % of the epoxide groups relative to a total number of moles of monomers present in the elastomeric polymer.

56. The process of claim 48, wherein the elastomeric polymer comprising epoxide groups is a homopolymer or copolymer with elastomeric properties, comprising greater than or equal to 2 mol % and less than or equal to 40 mol % of the epoxide groups relative to a total number of moles of monomers present in the elastomeric polymer.

57. The process of claim 48, wherein the elastomeric polymer comprising epoxide groups comprises a glass transition temperature less than 23° C.

58. The process of claim 48, wherein the elastomeric polymer comprising epoxide groups comprises an average molecular weight greater than or equal to 2,000 and less than or equal to 1,000,000.

59. The process of claim 48, wherein the elastomeric polymer comprising epoxide groups comprises an average molecular weight greater than or equal to 50,000 and less than or equal to 500,000.

60. The process of claim 48, wherein the elastomeric polymer comprising epoxide groups is an epoxidized diene homopolymer or copolymer derived from one or more conjugated diene monomers, optionally copolymerized with monovinylarenes, polar comonomers, or monovinylarenes and polar comonomers.

61. The process of claim 48, wherein the elastomeric polymer comprising epoxide groups is epoxidized natural rubber.

62. The process of claim 48, wherein the elastomeric polymer comprising epoxide groups is a copolymer of one or more monoolefins with an olefinic comonomer comprising one or more of the epoxide groups.

63. The process of claim 48, wherein the oligomer of a fatty acid is present in an amount greater than or equal to 3%-by-weight and less than or equal to 50%-by-weight relative to a weight of the elastomeric polymer comprising epoxide groups.

64. The process of claim 48, wherein the oligomer of a fatty acid is present in an amount greater than or equal to 10%-by-weight and less than or equal to 30%-by-weight relative to a weight of the elastomeric polymer comprising epoxide groups.

65. The process of claim 48, wherein the at least one elastomeric material comprises an effective amount of a coupling catalyst.

66. A tyre for a vehicle wheel, comprising:
one or more components made of crosslinked elastomeric material;
wherein the crosslinked elastomeric material of at least one of the components comprises an elastomeric polymer comprising epoxide groups crosslinked by reaction with an oligomer of a fatty acid;
wherein the elastomeric polymer comprising epoxide groups is crosslinked substantially in an absence of additional crosslinking agents; and
wherein said elastomeric polymer comprising epoxide groups is the only polymer of said crosslinked elastomeric material.

67. The tyre of claim 66, wherein the crosslinked elastomeric material further comprises a reinforcing filler.

68. The tyre of claim 66, wherein the oligomer of a fatty acid comprises a dimer, a trimer, or a mixture of a dimer and a trimer.

69. The tyre of claim 66, wherein the elastomeric polymer comprising epoxide groups is a homopolymer or copolymer with elastomeric properties, comprising greater than or equal to 1 mol % and less than or equal to 60 mol % of the epoxide groups relative to a total number of moles of monomers present in the elastomeric polymer.

70. A tyre for a vehicle, comprising:
a carcass structure;
a belt structure; and
a tread band;
wherein the belt structure extends coaxially around the carcass structure,
wherein the tread band extends coaxially around the belt structure,
wherein the tread band comprises, externally, a rolling surface intended to come into contact with the ground,
wherein the tread band further comprises an elastomeric polymer comprising epoxide groups crosslinked by reaction with an oligomer of a fatty acid,
wherein the elastomeric polymer comprising epoxide groups is crosslinked substantially in an absence of additional crosslinking agents, and
wherein said elastomeric polymer comprising epoxide groups is the only polymer of said tread band.

71. The tyre of claim 70, wherein the tread band further comprises a reinforcing filler.

72. The tyre of claim 70, wherein the oligomer of a fatty acid comprises a dimer, a trimer, or a mixture of a dimer and a trimer.

73. The tyre of claim 70, wherein the elastomeric polymer comprising epoxide groups is a homopolymer or copolymer with elastomeric properties, comprising greater than or equal to 1 mol % and less than or equal to 60 mol % of the epoxide groups relative to a total number of moles of monomers present in the elastomeric polymer.

74. A tread band comprising a crosslinkable elastomeric composition comprising:
an elastomeric polymer comprising epoxide groups; and
an oligomer of a fatty acid;
wherein the elastomeric polymer comprising epoxide groups is crosslinked substantially in an absence of additional crosslinking agents; and
wherein said elastomeric polymer comprising epoxide groups is the only polymer of said crosslinkable elastomeric composition.
